(19) United States
(12) Patent Application Publication
(10) Pub. No.: US 2010/0214395 A1
(43) Pub. Date: Aug. 26, 2010

(54) Camera System with Eye Finder Modules

(75) Inventor: Ralf Haussler, Dresden (DE)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SeeReal Technologies S.A., Munsbach (LU)

(21) Appl. No.: 12/711,521

(22) Filed: Feb. 24, 2010

(30) Foreign Application Priority Data
Feb. 26, 2009 (DE) 10 2009 001 202.8

(51) Int. Cl. H04N 13/04; H04N 7/18

(52) U.S. Cl. 348/51; 348/78; 348/E07.085; 348/E13.075

(57) ABSTRACT

The detection of the position of observer eyes in large object planes by a camera system with eye finder modules is disclosed, each of which comprises a camera with an objective lens and a camera chip. An embodiment is based on a camera system with two eye finder modules, where each eye finder module comprises an objective lens and a camera chip for detecting and determining the position of observer eyes in at least one object plane, and where the camera system is connected with a control unit.

### CROSS-REFERENCE TO RELATED APPLICATIONS

This application is based on and claims priority to German Application No. DE 10 2009 001 202.8, filed Feb. 26, 2009, the entire contents of which are fully incorporated herein by reference.

### BACKGROUND OF THE INVENTION

The present invention relates to the detection of the position of observer eyes in large object planes by a camera system with eye finder modules, where each eye finder modules comprises a camera with an objective lens and a camera chip. The camera system is connected with a control unit of an electro-optical display device. The invention further relates to a method for the detection of the position of observer eyes.

The field of application of this invention includes camera systems with at least two eye finder modules for the detection of the position of multiple observers who are provided three-dimensional information which is generated autostereoscopically and/or holographically in electro-optical display devices. The information can be 3D images or 3D video sequences, which may also be combined with two- or three-dimensionally displayed texts. Such electro-optical display devices are for example autostereoscopic or holographic display devices.

Devices for the detection of the position of eyes are known as position finders and usually comprise a camera system with two cameras which have identically designed objective lenses and a camera chip for each eye. The entire object plane is scanned according to an algorithm which realises the detection of at least two observer eyes. Once a face is detected, the algorithm further carries out a pattern detection routine to find the eye pupils and to determine their positions. If it does contain observer eyes, the entire object plane will be imaged onto the camera chip. The X, Y and Z co-ordinates of the observer eyes can be computed by way of comparing the positions of the detected eye pupils in the two object fields. This is possible because the two cameras see the observers from different positions and image them onto the camera chip with an offset which is characteristic of the observer position. The co-ordinates of the positions of the observer eyes are transmitted to a control unit. The control unit is a part of an electronic display device and generates for the detected position the desired 2D and/or 3D image content and the required visibility region from which the positioned observer eyes can see the image content.

If objective lenses with a great focal length are used for scanning the object plane, only small object fields can be scanned, and observer eyes could be overlooked at a high scanning speed. A small focal length of the objective lenses will result in greater object fields, but the spatial resolution of the objective lens will become smaller, because a certain region of the object field is imaged onto a smaller number of pixels of the camera chip. Since spatial resolution and object field size are fixedly interrelated, a compromise must be found between the spatial resolution and the size of the object field in the object plane when it comes to choosing the focal length of the objective lens. The combination of a high spatial resolution with a large object field would be ideal.

### SUMMARY OF THE INVENTION

It is therefore the object of the present invention to realise a large object field in an object plane for a camera system with at least two cameras which can be used for detecting the position of observer eyes, without thereby reducing the spatial resolution of the objective lenses. A pair of eyes in the object plane shall be found very fast and precise, and the eye pupil shall be detected unambiguously among multiple pairs of eyes, and its position shall be determined precisely in a short time.

The invention is based on a camera system with at least two eye finder modules, where each eye finder module comprises a camera with an objective lens and a camera chip for detecting and determining the position of observer eyes in at least one object plane, and where the camera system is connected with a control unit of a display device. The object is solved according to this invention in that each camera lens is assigned with an controllable array of micro prisms with a multitude of electrowetting cells. The objective lens and the controllable array of micro-prisms form a controllable combination for a sequential imaging and deflection of sub-regions of at least one object plane onto the entire photosensitive area of the camera chip, where the sub-regions lie within the depth-of-focus range of the controllable combination. The array of micro-prisms comprises a multitude of electrowetting cells, which are disposed either before or in the objective lens seen in the direction of light propagation.

The electrowetting cells form micro-prisms which realise both the function of a prism and that of a lens in the array of micro-prisms, depending on how they are controlled. The array of micro-prisms as a whole preferably realises the function of a Fresnel lens when being controlled accordingly.

The control unit controls the focal length of the Fresnel lens for the imaging onto the camera chip in dependence on a distance d between the at least one object plane and the controllable combination, where the at least one object plane includes at least one sub-region with observer eyes.

Further, the camera system comprises a control module which is connected with the control unit of the display device and which controls the controllable combination. According to an embodiment of this invention, the combination for the imaging of sub-regions in object planes is optionally controlled continuously or stepwise. If it is controlled stepwise, the number of sub-regions to be imaged onto the camera chip depends on the number of detected observer eyes in these sub-regions and/or on the position change of the detected observer eyes from one object plane into another object plane.

The sub-regions to be scanned gaplessly cover the entire area of an object plane. The camera system is preferably integrated into a display device for the three-dimensional representation of autostereoscopic and/or holographic information.

The invention further relates to a method for the detection of the position of observer eyes with a camera system with at least two eye finder modules, where each eye finder module comprises a camera with an objective lens and a camera chip for detecting and determining the position of observer eyes in at least one object plane, and where the camera system is connected with a control unit of a display device. The method according to this invention is characterised by a sequential imaging and deflection of sub-regions of at least one object plane onto the entire photosensitive area of the camera chip by combining the objective lens with a controllable array of micro-prisms which is assigned to the objective lens, where the sub-regions lie within the depth-of-focus range of the controllable combination of objective lens and array of micro-prisms.

The method is further characterised in that the detection of sub-regions in object planes is controlled either continuously or stepwise by a control module which is connected with the control unit of the display device. In a further embodiment of the method, detected sub-regions are imaged and deflected into the image planes with a lateral and axial offset in that the control module controls the micro-prisms of the array of micro-prisms such that the prism function and the lens function are realised one after another.

### DESCRIPTION OF THE DRAWINGS

The invention is described in more detail below with the help of embodiments and drawings. All drawings are schematic diagrams and show top views.

FIG. 1 a shows a first embodiment of a camera system according to this invention with an eye finder module which comprises an array of micro-prisms,

FIG. 1b shows the embodiment of FIG. 1a where the array of micro-prisms is controlled to realise a prism function,

FIG. 2a shows a second embodiment of a camera system according to this invention with an eye finder module with controlled array of micro-prisms which realises a lens function in a region of sharp focus, and

FIG. 2b shows the embodiment of FIG. 2a, where the region of sharp focus of the eye finder module was changed.

### DETAILED DESCRIPTION

The camera system for detecting eye positions on which this invention is based comprises at least two eye finder modules and a control module. Both eye finder modules are disposed in an electronic display device for 3D representations with a lateral offset. Since observer eyes can lie in different planes in front of the display device, the cameras of the eye finder modules are focused at a central plane. This plane will be referred to as the object plane hereinafter. Thanks to the lens function of the array of micro-prisms, it is possible to change between multiple object planes without having to readjust the cameras. Each eye finder module further comprises an array of micro-prisms. The eye finder modules are controlled by the control module, which is electrically connected with the control unit of the display device. The position of observer eyes can thus be detected in a time division multiplexing process. This means that the position information of observer eyes of detected faces can be determined one after another in a given range in front of the display device.

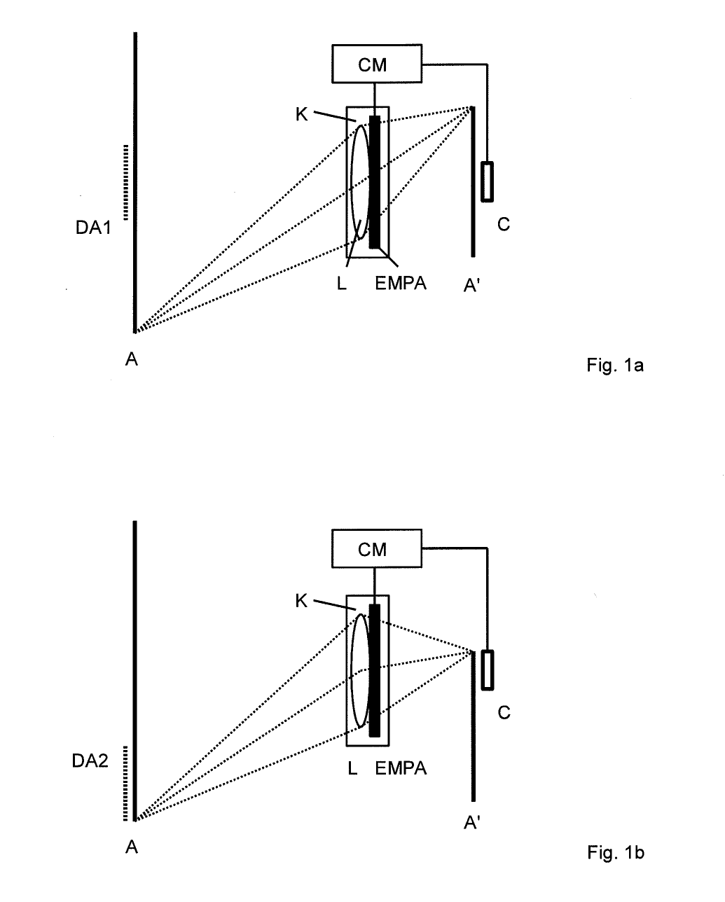

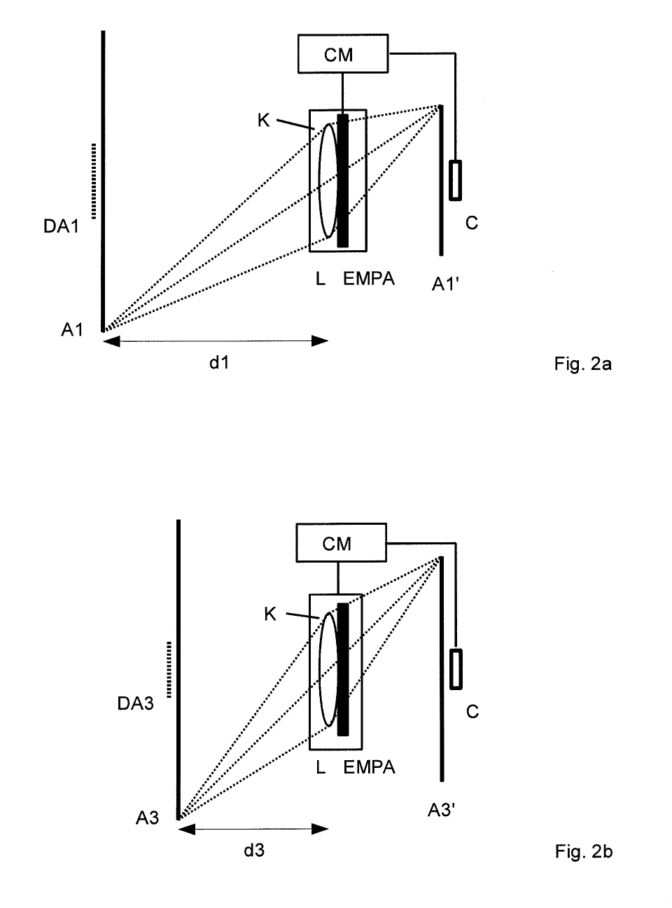

The embodiments shown in FIGS. 1a, 1b and 2a, 2b describe the design and function of an eye finder module for a left or a right eye. The second eye finder module of the camera system is designed analogously and realises the same function for the other eye, so that the position of observer eyes can be determined at least two-dimensionally.

FIGS. 1a and 1b are top views which schematically illustrate a first embodiment of an eye finder module with an array of micro-prisms EMPA according to this invention. Referring to FIG. 1b, in the first embodiment all electrowetting cells (EW cells) of the array EMPA are controlled such that micro-prisms are realised in the array EMPA. The array EMPA as a whole here has the optical function of a prism. All micro-prisms are controlled such that they deflect light in the same direction.

FIG. 1a shows schematically an eye finder module which comprises a camera with a camera chip C and an objective lens L, which can for example be realised in the form of a lens element. A controllable array of micro-prisms EMPA with a multitude of controllable EW cells is disposed immediately in front of the objective lens L in the optical path. The array EMPA can also be integrated into the objective lens L. The drawing further shows in the optical path an object plane A in which or near which faces are detected. ‘Near’ here means that the observers must be situated within a range which corresponds with the depth-of-focus range for the imaging of the object plane A into the image plane A′. The camera chip C is disposed as close as possible to the image plane A′. The objective lens L and the controllable array of micro-prisms EMPA together form a controllable combination K. The latter is controlled by a control module CM, which is further connected with the camera chip C and the control unit of the display device (not shown).

The controllable EW cells contain two or more immiscible liquids which are characterised by different refractive indices, where interfaces are generated between two immiscible liquids. The contact angle of the interface to the walls of the cell is controlled by applying a voltage to the electrodes which are disposed on the walls of the cells. Now, if the control voltage is chosen such that the contact angle of the liquids and all walls of the cell is 90°, the interfaces are situated at right angles to the optical path. Incident pencils of rays thus pass the EW cells of the array of micro-prisms EMPA without being deflected. This situation is illustrated in FIG. 1a. The optical path of the imaging of one point of the object plane A through the objective lens L into a point of the image plane A′ is indicated by dotted lines. The array of micro-prisms EMPA is switched such that is transmits the beams or pencils of rays without deflection. The camera chip C can for example be a CCD chip with photosensitive pixels which are arranged in a matrix. It is much smaller than the image plane A′. Therefore, only a sub-region DA1 (chain line in the drawing) of the object plane A is imaged onto it. The sub-region DA1 is somewhat larger than a face. The entire resolution of the camera chip C is available for this sub-region DA1. A single object plane A may comprise several sub-regions DAn, which are sequentially imaged onto the camera chip C. The image planes A′ of the sub-regions DAn are then imaged into a single plane but with a lateral offset.

The reproduction scale in this embodiment is found in that an area with the edge lengths A*A or A*B with the magnitude of few metres is imaged into an image plane which has an area with the edge lengths A′*A′ or A′*B′ with the magnitude of few centimetres. For example, the image plane A′ can have a size of 10 cm*10 cm, while the entire object plane A to be imaged measures about 3 m (horizontal)*3 m (vertical). The reproduction scale must be chosen such that a face is fully contained in the sub-region DA1. Since a face has dimensions of about 30 cm*30 cm, and the camera chip C has a size of about 1 cm*1 cm, the reproduction scale in this numerical example is 1:30.

In order to find at least one observer face in the given object plane A, the sub-regions of the entire object plane A are sequentially scanned in accordance with the algorithm already described above. If a face is detected, the algorithm will further carry out a pattern detection routine to find the eye pupils.

Compared to FIG. 1a, the observer has moved to a new position in FIG. 1b. The eye pupils which are detected in the sub-region DA2 must now be deflected and imaged onto the camera chip C. Therefore, the sub-region DA2 is imaged by the combination K, which comprises the objective lens L and the array of micro-prisms EMPA, into the image plane A′ and onto the camera chip C. For this, the interfaces of the EW cells of the array EMPA are controlled by control signals provided by the control module CM such that they change their inclination angle, thereby forming micro-prisms in the array EMPA. The inclination angles of the interfaces are e.g. the same in all EW cells, so that they deflect incident pencils of rays in a defined manner. The sub-region DA2 (chain line) of the object plane A is both completely imaged onto the camera chip C and offset in the image plane A′ e.g. to the left compared to the situation shown in FIG. 1a.

The sub-regions in the object planes can be detected either continuously or stepwise, where the EW cells are controlled by a control module which is connected with the control unit of the display device. If the EW cells are controlled continuously, the deflection angles of the interface will be varied continuously, so that multiple sub-regions DAn of same size are detected sequentially one after another within the entire area of the object plane A. These sub-regions DAn gaplessly cover the entire object plane A. They are imaged one after another into different regions of the image plane A′, but always onto the camera chip C. The entire resolution of the camera chip C is available for each of these sub-regions. A large object plane A can thus be scanned and imaged sequentially at a high resolution.

If the continuous control method is used, the entire object plane A is imaged sequentially, irrespective of whether a face is situated in each of the sub-regions DAn. However, a stepwise control is deemed to be more preferable. Here, only those sub-regions DAn are imaged which actually contain faces. If the EW cells are controlled stepwise, the entire object plane A is first scanned sequentially with the help of the array of micro-prisms in order to find those sub-regions which contain faces. In a subsequent step of the eye position detection algorithm, the exact position of the eyes is determined in those detected sub-regions which contain the faces. Then, only those sub-regions DAn of the object plane A which actually contain a face are sequentially imaged. It is only in larger intervals (e.g. every 1 s) that the respective object plane will be scanned entirely again in order to find out whether persons have substantially moved away from their initial position, and whether new persons have entered the object plane.

The control signals of the detected position of observer eyes of the control module CM supply the input information for the provision of output information for the image information and, in synchronism with that, for the generation of the visibility regions for a detected position of a left observer eye and that of a right observer eye. The input and output information is further processed and synchronised in the control unit of the display device.

A great advantage of the array of micro-prisms is that it can be switched very quickly. This makes it possible to scan the respective object plane An very quickly and to determine the eye positions of multiple observers sequentially at a very fast pace. Since the full resolution of the camera chip C is available for the sub-regions DAn to be imaged of the respective object plane An, these sub-regions can be imaged by the objective lens L into the image plane A′ at a high resolution without the need to increase the resolution of the camera chip C by taking additional measures.

A second embodiment of the array of micro-prisms EMPA is illustrated in FIGS. 2a and 2b. In this embodiment, the EW cells are designed such and are controlled with different voltages such that the array EMPA still forms micro-prisms, but which realise the optical function of a lens. This means that the total effect of all EW cells of the controllable array of micro-prisms EMPA is that of a lens. Not all micro-prisms of the EW cells are controlled the same way. Their interfaces are controlled by the control module CM such that there are different inclinations in the individual EW cell and that all interfaces as a whole form a controllable Fresnel lens. This makes it possible for the object plane A to be displaced as regards its distance to the controllable combination K of the array EMPA and objective lens L and to be imaged in a focused manner into the plane of the camera chip C. The positions of the observer eyes and a change in their positions in the direction towards the camera chip C can thus be detected.

To be able to realise the lens function, the array of micro-lenses is controlled by the control module CM such that the individual EW cells form a Fresnel lens with a certain focal length or refractive power. The refractive power of the Fresnel lens and the refractive power of the objective lens L approximately add to a total refractive power whose reciprocal value is the total focal length f of the controllable optical system. With this total focal length f, a plane at the distance d is generally imaged into the plane of the camera chip C, where the following equation applies in approximation:

1/f=1/d+1/c

where c is the distance between the objective lens L and camera chip C. All distances given here relate to the main planes of the controllable optical system.

FIG. 2a shows the initial condition of a control for realising a lens function. The total focal length f of the controllable combination K is controlled by the control module CM such that an object plane A1 with a distance d1 to the array EMPA is imaged into the image plane A1′ and onto the camera chip C. A Fresnel lens is formed whose focal length can be changed by way of controlling the micro-prisms of the array EMPA accordingly. This is shown in FIG. 2b.

Referring to FIG. 2b, a sub-region DA3 of the object plane A3 with a distance d3 to the array EMPA can also be imaged into the image plane A3′ and onto the camera chip C thanks to the changed focal length. The surface areas of the sub-regions DA1 and DA3, which are always sequentially imaged onto the entire surface are of the camera chip C, vary depending on the newly set focal length. The depth-of-focus range of the eye finder module can thus be extended beyond the depth of focus which an objective lens with fixed focal length has.

The arrangements described in the two embodiments above and the method procedure can be combined in a third embodiment. A sub-region DA of an object plane A can be displaced both laterally in this plane and axially into another plane, e.g. A3, by the array EMPA in order to detect and to image faces, so to be able to follow the eyes of the detected face whose movement in front of the display device has not yet been completed. The final position of the sub-region DA3 of the observer is then imaged onto the camera chip C. Detecting and imaging take place in a time division multiplexing process within a given period of time, preferably several times per second.

Since the camera system has two identical eye finder modules which are directed at object planes, the one eye finder module must carry out the same procedure in synchronism with other. Both eye finder modules must detect and image the same sub-region of an object plane at any one time. It is now possible for the computer of the control unit to compute the X, Y and Z co-ordinates of the eye pupils in conjunction with the offset of the camera positions and the consequential offset of the positions of the eye pupils.

The eye finder module according to this invention allows faces and corresponding eye positions to be determined in different object planes in a large range in front of the display device in two or three dimensions. Since according to this invention only small sub-regions of those planes are imaged to the entire area of the photosensitive surface of the camera chips of the camera system, an eye detection is still possible at a high resolution.

The present invention is not restricted to the embodiments for the detection of the position of observer eyes described above, but embraces all and any combinations which are deemed to be covered by this invention by a person skilled in the art.

1. Camera system with at least two eye finder modules, where each eye finder module comprises a camera with an objective lens and a camera chip for detecting and determining the position of observer eyes in at least one object plane, and where the camera system is connected with a control unit of a display device, wherein the objective lens (L) is combined with a controllable array of micro-prisms (EMPA) for a sequential imaging and deflection of sub-regions (DA1, . . . , DAn) of at least one object plane (A, . . . , Am) onto the entire photosensitive area of the camera chip (C), where the sub-regions (DA1, . . . , DAn) lie within the depth-of-focus range of the controllable combination (K) of objective lens (L) and controllable array of micro-prisms (EMPA).

2. Camera system according to claim 1, where the array of micro-prisms (EMPA) comprises a multitude of electrowetting cells, which are disposed either before or in the objective lens (L) seen in the direction of light propagation.

3. Camera system according to claim 2, where the electrowetting cells form micro-prisms which realise both the function of a prism and that of a lens in the array of micro-prisms (EMPA), depending on how they are controlled.

4. Camera system according to claim 3, where the array of micro-prisms (EMPA) as a whole realises the function of a Fresnel lens when being controlled accordingly.

5. Camera system according to claim 4, where the control unit controls the focal length of the Fresnel lens for the imaging onto the camera chip (C) in dependence on a distance d between the at least one object plane (Am) and the controllable combination (K), where the at least one object plane (Am) includes at least one sub-region (DAn) with observer eyes.

6. Camera system according to claim 1, where a control module (CM) is provided which is connected with the control unit of the display device and which controls the combination (K).

7. Camera system according to claim 6, where the combination (K) for the imaging of sub-regions (DA1, . . . , DAn) in object planes (A, . . . , Am) onto the camera chip (C) is optionally controlled continuously or stepwise.

8. Camera system according to claim 7, where, if stepwise control is executed, the number of sub-regions (DA1, . . . , DAn) to be imaged onto the camera chip (C) depends on the number of detected observer eyes in these sub-regions and/or on the position change of the detected observer eyes from one object plane into another object plane.

9. Camera system according to claim 1, where the sub-regions (DA1, . . . , DAn) gaplessly cover the entire surface area of an object plane (Am).

10. Camera system according to claim 1, which is integrated into a display device for the three-dimensional representation of autostereoscopic and/or holographic information.

11. Method for the detection of the position of observer eyes with a camera system with at least two eye finder modules, where each eye finder module comprises a camera with an objective lens and a camera chip for detecting and determining the position of observer eyes in at least one object plane, and where the camera system is connected with a control unit of a display device, wherein a sequential imaging and deflection of sub-regions (DA1, . . . , DAn) of at least one object plane (A, . . . , Am) onto the entire photosensitive area of the camera chip (C) is executed by combining the objective lens (L) with a controllable array of micro-prisms (EMPA) which is assigned to the objective lens (L), where the sub-regions (DA1, . . . , DAn) lie within the depth-of-focus range of the controllable combination (K) of objective lens (L) and array of micro-prisms (EMPA).

12. Method according to claim 11, where the detection of sub-regions (DA1, . . . , DAn) in object planes (A, . . . , Am) is controlled either continuously or stepwise by a control module (CM) which is connected with the control unit of the display device.

13. Method according to claim 12, where detected sub-regions (DA1, . . . , DAn) are imaged into the image planes (A′, . . . , An′) with a lateral and axial offset and deflected in that the control module (CM) controls the micro-prisms of the array of micro-prisms (EMPA) such that the prism function and the lens function are realised one after another.
